(19) United States
(12) Patent Application Publication
(10) Pub. No.: US 2020/0298883 A1
(43) Pub. Date: Sep. 24, 2020

(54) METHOD FOR DETERMINING AN ATTITUDE OF AN AT LEAST PARTIALLY AUTONOMOUSLY MOVING VEHICLE USING SPECIALLY SELECTED LANDMARKS TRANSMITTED FROM A BACK-END SERVER

(71) Applicant: Robert Bosch GmbH, Stuttgart (DE)

(72) Inventors: Holger Mielenz, Ostfildern (DE); Jan Rohde, Stuttgart (DE)

(73) Assignees: Robert Bosch GmbH, Stuttgart (DE); Robert Bosch GmbH, Stuttgart (DE)

(21) Appl. No.: 16/088,383

(22) PCT Filed: Feb. 6, 2017
(86) PCT No.: PCT/EP2017/052484

§ 371 Date: Sep. 25, 2018

(30) Foreign Application Priority Data
Apr. 8, 2016 (DE) 102016205866.5

(51) Int. Cl. B60W 60/00; G01C 21/36; G01C 21/34; G06K 9/00

(52) U.S. Cl. CPC B60W 60/0025; G06K 9/00791; G01C 21/3461; G01C 21/3614

(57) ABSTRACT

A method for determining an attitude of an at least partially autonomously moving vehicle using landmarks, a back-end server being provided, by which landmark data of the landmarks are transmitted from a map to a vehicle control system of the vehicle. According to the system and method, landmark data to be transmitted are selected as a function of environmental influences and a transmission of landmark data from the back-end server to the vehicle control system is limited to the selection made.

### FIELD OF THE INVENTION

The present invention relates to a method for determining an attitude of an at least partially autonomously moving vehicle using landmarks, a back-end server being provided, which transmits landmark data of the landmarks from a map to a vehicle control system of the vehicle.

### BACKGROUND INFORMATION

In the realm of technology, an attitude is understood as the spatial aspect of an object, namely, the position and the orientation of an object in two-dimensional space or in three-dimensional space.

The method for determining the attitude of the vehicle is based at least additionally on landmarks of various types in the surroundings of the vehicle, it being possible that GPS data form a basis of an attitude. For this purpose, based on GPS data, attitude data of the vehicle may be enriched with data that are generated from the detection of landmarks. With the aid of landmarks, it is largely possible to determine in particular the orientation, for example the direction of travel of the vehicle. The accuracy of the determination of the attitude of the vehicle based on landmarks is greater than the accuracy of the determination by GPS data. In partially autonomously moving vehicles, in particular in vehicles that in future will move in a fully autonomous manner, pure GPS navigation is no longer sufficient to guide the vehicle, and systems must be used that detect the immediate surroundings of the vehicle and that guide the vehicle in particular by detecting landmarks. The term vehicle control system comprises essentially all components that are required for detecting the attitude, for evaluating the data and ultimately for controlling the vehicle. The vehicle control system comprises in particular detectors such as laser, radar and infrared sensors, capacitive sensors, LIDAR sensors and/or a video image recorder.

Patent document DE 10 2014 206 901 A1 discusses for example a method for determining the attitude of an at least partially autonomously moving vehicle in an environment. The situation detection is based on the one hand on a surroundings detection using a surround sensor system, comprising ultrasonic, laser, radar, infrared, and capacitive sensors, LIDAR sensors and/or a video image recorder. When the vehicle is moving in traffic, the situation detection is to be based on detecting objects outside of the vehicle, indicators being relevant for this purpose, which also indicate a specific situation. These may be for example optical markers, objects or demarcations. Additionally or alternatively, additional technologies may be used for localization in order to improve the accuracy of the situation detection, it thus being possible to ascertain geodetic lines using a GPS system or digital maps with landmarks in combination with an odometry. Landmarks in this context are objects in the immediate surroundings of the vehicle, including for example also traffic signs such as traffic lights and the like as well as road markers.

The basis for perceiving the surroundings of the vehicle are thus measurement data obtained by detectors, from which it is possible to extract objects with the aid of detector algorithms.

On the basis of these objects, it is possible to model the surroundings of the vehicle in order thus to plan for example a trajectory for one's own vehicle and to be able to make other decisions of action.

The quality of the model of the surroundings depends greatly on the surround sensor system used. These differ in their measuring properties with respect to accuracy and range depending on the system, and their performance normally depends to a significant degree on environmental conditions such as rain, fog, exposure to sunlight or artificial illumination, for example. For example, it is not possible for a road marker to function reliably as a landmark if the roadway is wet and especially when it is dark since a wet roadway may reflect light especially in darkness so that the respective detectors cannot be activated, although other detectors continue to function in these weather conditions.

Not all types of landmarks are equally affected by such influencing factors, however. Signaling systems for example are normally readily detectable regardless of weather conditions, whereas in detection systems that operate optically for example it is not possible in all lighting conditions reliably to model the surroundings corresponding to physical objects in the immediate environment of the vehicle.

In addition to information from the measured sensor data of the detectors, increasingly information from maps is used as an important additional source for determining the attitude of the vehicle. This information may be transmitted from a central map server or back-end server to the respective vehicle, such a server being referred to simply as a back-end server in the following. In the vehicle control system, the surroundings information that was detected by the vehicle detectors is then amalgamated with the surroundings information from the back-end server so as to achieve a substantially higher quality for generating a surroundings model.

If the back-end server transmits all landmarks from the map to the vehicle control system, this produces a substantial density of information, which utilizes possibly to an unnecessary degree an available bandwidth of the communication channel between the back-end server and the control system of the vehicle. The computing capacity of the vehicle control system is also limited on the hardware side so that it is desirable to reduce the quantity of data transmitted from the back-end server to the vehicle control system.

### SUMMARY OF THE INVENTION

The objective of the present invention is the further development of a method for determining an attitude of an at least partially autonomously moving vehicle, the aim being to configure the method in such a way so that only a limited quantity of data need be transmitted from the back-end server to the vehicle control system. An objective is also to reduce the required computing capacity and the quantity of data to be processed for the vehicle control system. The partially autonomously moving vehicle is to continue to be able to be controlled safely without change.

This objective is attained on the basis of a method according to the descriptions herein and on the basis of a vehicle control system according to the descriptions herein having the respectively described features. Advantageous refinements of the present invention are specified in the further descriptions herein.

The present invention comprises the technical teaching that a selection is made of the landmark data to be transmitted as a function of environmental influences, a transmission of landmark data from the back-end server to the vehicle control system being limited to the selection made.

The essence of the present invention is the inclusion of sensible environmental influences, on the basis of which only such landmark data are transmitted from the back-end server to the vehicle control system as may be expediently used by the vehicle control system, depending on the detected current environmental conditions, that is, primarily depending on the time of day and weather influences, in order to produce a surroundings model of a respectively high quality.

The transmitted surroundings information must have a certain additional informational value for the vehicle control system that at least exceeds the information that the vehicle control system already receives via the detectors for detecting the immediate surroundings. Thus landmarks may be transmitted, which may also be detected by the detectors of the vehicle so that additional landmarks are not transmitted which would then be available to the vehicle control system, but which would not be able to be sensed due to environmental influences. Positions of landmarks that are readily detectable under current conditions by the surround sensors of the vehicle control system, that is, for example actively luminous light sources at night, may therefore be transmitted by the back-end server from the stored map material to the vehicle control system. The current situation, which may be detected, for example by rain sensors, light sensors, temperature sensors and the like, allows for an assertion about types of landmarks that may be readily detected and types of landmarks that may not be readily detected. Currently poorly detectable landmarks should therefore be transmitted only if on the basis of the normally readily detectable landmarks, e.g. in the form of a localization, a localization is not readily possible. By using the situation-dependent transmission of information about landmarks in accordance with the present invention, it is possible to utilize the computing capacity of the vehicle control system in optimized fashion. In this manner it is possible to lower the costs for the vehicle electronics and the communication infrastructure significantly.

The environmental influences are for example the weather, the time of day, traffic, visibility, lighting conditions and/or wetness, as well as road markings, traffic jams, strong oncoming traffic that may obscure landmarks, preceding vehicles and the like. The environmental influences are detected by surround sensors of the vehicle and are transmitted to the vehicle control system.

For example, when the road is wet and reflective, especially in darkness, road markers are disregarded so that corresponding detectors for detecting road markers are not activated and an associated transmission of the specific data from the back-end server to the vehicle control system is not activated. There may also be a provision that, in the event of light of oncoming traffic, illumination devices, for example traffic signaling systems or the illumination of preceding vehicles, are disregarded since, especially in the event of light of oncoming traffic, a corresponding detection is not expediently possible and a corresponding detection quality is not attainable so that in the event of light of oncoming traffic corresponding signaling systems offer only little information content.

One advantageous refinement of the present invention provides for an information service that transmits environmental influences relevant to the location of the vehicle to the back-end server. A possible information service is a weather service for example, which transmits weather data from the location or from the surroundings of the vehicle to the back-end server. There is furthermore the possibility of providing information from especially equipped additional vehicles that form the information service.

The vehicle has detectors, which detect landmarks, the landmark data transmitted from the back-end server to the vehicle control system being amalgamated with the landmarks detected by the detectors so that a substantially higher quality for producing a surroundings model is achievable.

To improve the implementation of the method there may be a provision for the transmission of specific landmarks from the back-end server to the vehicle control system to be trained automatically using desired landmarks as a function of the environmental influences. For example, it is possible to recognize empirically analyzed connections between landmarks and the achievable quality of the detection as a function of environmental influences such a weather, lighting conditions, illumination and the like so that the vehicle control system against the background of a specific environmental scenario assigns corresponding landmarks and categorizes other landmarks for example and disregards them. Such training result in a continuous improvement of the functioning of the vehicle control system and to an increasingly resource-conserving usage. Training may in particular comprise the selection of landmarks provided by the back-end server so that a continuously progressing optimization of the surroundings-based transmission of specific landmarks becomes possible as a function of likewise specified environmental conditions.

According to another advantageous improvement of the method, a selection is made of a detection algorithm for processing the landmark data of specific landmarks additionally as a function of localization scenarios. This makes it possible to achieve a further improvement of the method, and, if the quantity of landmark data is increased or decrease as needed depending on the localization scenarios, this yields the advantage of a smaller amount of data for determining the attitude of the vehicle, the amount of data for processing in the vehicle control system being reduced in addition to a decreased transmission rate from the back-end server.

The selection of specific detectors may be performed by the vehicle control system in such a way that it is possible to switch between different detectors, it being possible for example to switch detectors and associated detection algorithms on or off.

The present invention furthermore relates to a vehicle control system for implementing a method for determining the attitude of an at least partially autonomously moving vehicle using various landmarks, a back-end server being provided, which transmits landmark data of the landmarks from a map to a vehicle control system of the vehicle. The present invention provides for selecting landmark data to be transmitted as a function of environmental influences and for limiting a transmission of landmark data from the back-end server to the vehicle control system to the selection made. Additional features and associated advantages of the method described above are likewise taken into consideration for the vehicle control system.

Further measures improving the present invention are presented in greater detail below with reference to the figures together with the description of an exemplary embodiment of the present invention.

### BRIEF DESCRIPTION OF THE DRAWINGS

FIG. 1 shows a diagram for implementing the method of the present invention with environmental influences shown in exemplary fashion, an information service and a back-end server as well as a vehicle.

FIG. 2 shows an example of a construction of a vehicle control system having a back-end server for providing data about landmarks as a function of environmental influences.

### DETAILED DESCRIPTION

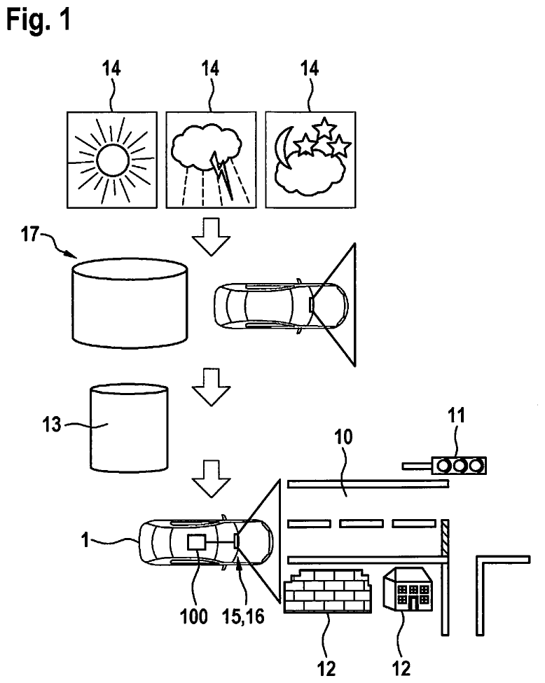

FIG. 1 illustrates an operational sequence of the method according to the present invention. By way of example, three different environmental influences 14 are shown such as rays of sunlight, which may blind for example, rain, which impedes the detection of road markers for example, or nighttime, during which more distant landmarks such as buildings or the like are more difficult to detect.

The information about the environmental influences shown in exemplary fashion is transmitted by an information service 17 to back-end server 13. Information service 17 is provided for example by a weather service or by other vehicles that are able to provide data about environmental influences by way of special sensors.

Finally, back-end server 13 receives the data about environmental influences 14 and, depending on the current environmental influences, selects specific landmarks that are transmitted to vehicle 1. In vehicle control system 100 of vehicle 1, the surroundings information that was detected by vehicle detectors 15, 16 is then amalgamated with the surroundings information of back-end server 13 so as to achieve a higher quality for generating surroundings model 19. Landmarks 10, 11, 12 such as road markers 10, traffic sign 11 and immobile objects such as houses or walls 12 are shown by way of example.

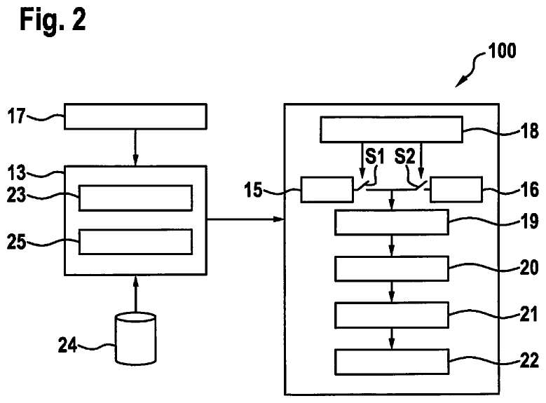

FIG. 2 shows a vehicle control system 100 including a detailed illustration of individual components. Furthermore, a back-end server 13 is shown for transmitting landmark data to vehicle control system 100.

Vehicle control system 100 has multiple detectors 15 and 16, only two detectors 15, 16 being shown by way of example. A module 18 may be used to switch detectors 15, 16 with the aid of switches S1 or S2, depending on what kind of landmarks 10, 11, 12 are to be detected.

If either detector 15 or detector 16 or both detectors 15 and 16 are activated, a surroundings model 19 may be ascertained so that following a situation analysis 20 it is ultimately possible to provide a function 21, by which an action for guiding the vehicle is output using actuator system 22.

Aside from vehicle control system 100, a back-end server 13 is shown schematically. This is located, by way of example, in a stationary location outside of vehicle 1 and is configured to transmit landmark data for example from a map to vehicle control system 100. According to the present invention, back-end server 13 receives from an information service 17 data about current environmental influences 14 such as the weather, the time of day and the like. As a function of these data, back-end server 13 selects specific landmarks 10, 11, 12 following a specified and/or trained model, which are particularly suitable for vehicle control system 100 to prepare the surroundings model 19 given the environmental influences 14. Data about landmarks 10, 11, 12, which are less suitable for preparing surroundings model 19 since they cannot be detected or recognized by detectors 15, 16, are not transmitted.

In vehicle control system 100, the surroundings information that was detected by vehicle detectors 15, 16 is then amalgamated with the surroundings information of back-end server 13 so as to achieve a higher quality for generating surroundings model 19.

In a step 23, the back-end server makes a selection of weather-specific landmarks 10, 11, 12, which are retrieved from a map memory 24. Finally, in a step 25, the selected landmark data are transmitted to vehicle control system 100, as indicated by an arrow between back-end server 13 and vehicle control system 100.

The present invention is not limited in its embodiment to the exemplary embodiment indicated above. Rather, a number of variants is conceivable which make use of the design approach shown, even for fundamentally different types of embodiments.

All of the features and/or advantages yielded by the claims, the description or the drawings, including constructional details, spatial arrangements and method steps may be essential to the present invention both per se and in the most varied combinations.

1-9. (canceled)

10. A method for determining an attitude of an at least partially autonomously moving vehicle using landmarks, the method comprising:
transmitting, from a back-end server, landmark data of the landmarks from a map to a vehicle control system of the vehicle; and
selecting the landmark data, which are to be transmitted, as a function of environmental influences;
wherein a transmission of the landmark data from the back-end server to the vehicle control system is limited to the selected landmark data.

11. The method of claim 10, wherein the environmental influences include the weather, the time of day, traffic, visibility, lighting conditions and/or wetness.

12. The method of claim 10, wherein an information service transmits environmental influences relevant to the location of the vehicle to the back-end server.

13. The method of claim 12, wherein the information service is provided by at least one weather service or by special vehicles.

14. The method of claim 10, wherein the vehicle has detectors, which detect landmarks, the landmark data transmitted from the back-end server to the vehicle control system being amalgamated with the landmarks detected by the detectors.

15. The method of claim 10, wherein the vehicle control system is trained automatically using landmarks to be used depending on the environmental influences.

16. The method of claim 10, wherein the selection of the landmark data of specific landmarks to be transmitted by the back-end server is additionally performed as a function of at least one localization scenario.

17. The method of claim 10, wherein the vehicle control system switches various detectors on or off while determining an attitude of the vehicle.

18. A vehicle control system for determining an attitude of an at least partially autonomously moving vehicle using landmarks, comprising:
a processing device for determining the attitude of the at least partially autonomously moving vehicle using the landmarks, by performing the following:
transmitting, from a back-end server, landmark data of the landmarks from a map to a vehicle control system of the vehicle; and
selecting the landmark data, which are to be transmitted, as a function of environmental influences;
wherein a transmission of the landmark data from the back-end server to the vehicle control system is limited to the selected landmark data.
